(19) United States
(12) Patent Application Publication
(10) Pub. No.: US 2008/0102713 A1
(43) Pub. Date: May 1, 2008

(54) Terminal housing battery cable connector clamp and fastening bolt

(76) Inventors: Charles M. Orange, Nashville, TN (US); Steven A. Eller, Goodlettsville, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/591,419

(22) Filed: Nov. 1, 2006

(51) Int. Cl. H01R 4/38

(52) U.S. Cl. 439/765

(57) ABSTRACT

A battery cable clamp is provided with a clamp shaft having a distal male threaded end adapted to mate with a female threaded nut positioned in a terminal housing, said clamp shaft carrying a cam seat, a cammed handle with pin, and a locknut, wherein the cammed handle is operable to frictionally engage and release the distal male threaded shaft end and female threaded nut and the nut has a raised lip to position the nut in the terminal housing.

The present invention relates generally to battery cable clamps and more particularly to a battery cable clamp adapted for use with a fastening bolt configured to fit within a terminal housing so that the battery cable may be easily fastened and released by hand.

### BACKGROUND ART

It will be appreciated by those skilled in the art that most automobiles, motorized vehicles, and inboard boats are started by battery power and that the standard modern battery is a 12-volt battery having metal top-post terminals for the opposing polarities of the battery to which the terminals of battery cables are attached. Some of these top-post battery terminals are configured as housings that receive a nut, and a bolt is fastened through a wall of the terminal housing into the nut, thereby clamping a battery cable connector to the terminal housing. The standard nut for use in a terminal housing is a cube or rectangular prism with a threaded aperture extending through the nut. A bolt is received through the aperture of the battery cable connector plate into an opening in the housing and then into the female threaded aperture of the nut, and the cable connector plate is bolted into contact with the terminal housing to establish an electrical connection.

The terminal housing structure is most commonly found on motorcycle batteries and the location of openings in the housing may allow the battery cable to be fastened to the top, front or side of the terminal housing as desired. Many standard 12-volt batteries last for several years, especially when used sparingly, as in some recreational boats. During the course of the life of a battery, corrosion build up may occur and battery terminal hardware may not be easily turned. Accordingly, it is often necessary to tap the hardware lightly with a hammer or to try rotating the cable and connector plate slightly as a wrench is used to turn the bolt. Due to cramped conditions, it can be difficult to carry out these or other steps to loosen the terminal hardware. In other cases, the hardware may be sufficiently bound that it is necessary to cut the battery cable in order to remove the battery.

Another difficulty with terminal housing hardware is the difficulty of aligning the threaded aperture of the nut directly behind the desired opening of the terminal housing to permit the bolt to easily enter the aperture. In cramped conditions, it may be very difficult to hold a nut in place with respect to the terminal housing while simultaneously moving the nut with battery cable connector into position to fasten the bolt into the nut.

What is needed then, is a terminal housing battery cable connector that will overcome the problems of prior art devices.

### SUMMARY OF THE INVENTION

Instead of the standard bolt which passes through a battery terminal housing opening and is tightened into a female aperture of a nut, an improved battery cable connector clamp may utilize a bolt with a clamping handle. The bolt with clamping handle (in open position) can be inserted through the aperture of the cable connector plate and into an opening of the terminal housing and loosely screwed into the female threaded aperture of the fastening nut. The clamping handle includes a boss or camming structure that increases the clamping pressure based upon the angular rotation of the handle with respect to the bolt. By moving the clamping handle to its closed position, the connector plate is firmly engaged against the conductive terminal housing. When it is desired to remove the battery cable, the handle can be released to its open position and a substantial decrease in the clamping pressure of the bolt against both the terminal housing and the female threads of the fastening nut results. The handle rotates loosely in axial directions and does not turn the bolt on which it is mounted. In this fashion the handle can be rotationally oriented in any direction required in a restricted space. Preferably, the components of the terminal housing battery connection clamp assembly are made of non-corrosive and in some cases non-metallic materials such as stainless steel and glass filled nylon. In this fashion, preferably the entire operation of the invention is possible without need for using any additional tools.

To facilitate alignment of the female threaded aperture of the fastening nut with an opening in the terminal battery, the nut is provided with a positioning lip. The lip restrains the nut against insertion into the terminal housing beyond the point where the threaded aperture of the nut is aligned with the terminal housing opening.

### BRIEF DESCRIPTION OF THE DRAWINGS

These and other objects of the invention will be explained in greater detail in connection with the following drawings of the preferred embodiments of the invention:

FIG. 1A is an illustration of a representative battery with terminal housings and a prior art fastening nut, cable and bolt aligned to fasten the cable connector to the front of the terminal housing.

FIG. 1B is a terminal housing, fastening nut, cable and bolt of the prior art aligned to fasten the cable connector to the top of the terminal housing.

FIG. 2A is a perspective view of a battery cable clamp that may advantageously be used with the present invention.

FIG. 2B is a side plan view of the clamp of FIG. 2A.

FIG. 3A is a perspective view of the bolt member of the clamp of FIG. 2A.

FIG. 3B is a side plan view of the bolt of FIG. 3A.

FIG. 4A is a perspective view of the seat of the clamp of FIG. 2.

FIG. 4B is a side sectional view of the seat of FIG. 4A.

FIG. 4C is a top plan view of the seat of FIG. 4A.

FIG. 5A is a perspective view of the handle of the clamp of FIG. 2.

FIG. 5B is a top plan view of the handle of FIG. 5A.

FIG. 5C is a bottom plan view of the handle of FIG. 5A.

FIG. 5D is a side plan view of the handle of FIG. 5A.

FIG. 6A is a perspective view of the pin of the clamp of FIG. 2.

FIG. 6B is a side sectional view of the pin of FIG. 6A.

FIG. 7A is a perspective view of a reinforcing insert for the cap of the clamp of FIG. 2.

FIG. 7B is a side plan view of the insert of FIG. 7A.

FIG. 8A is a perspective view of the cap of the clamp of FIG. 2.

FIG. 8B is a side plan view of the cap of FIG. 8A.

FIGS. 9A-9F are front, side and top plan views of prior art terminal housings and isometric views of the associated fastening nuts.

FIGS. 10A-10F are isometric views of fastening nuts with positioning lips.

### DETAILED DESCRIPTION OF THE INVENTION

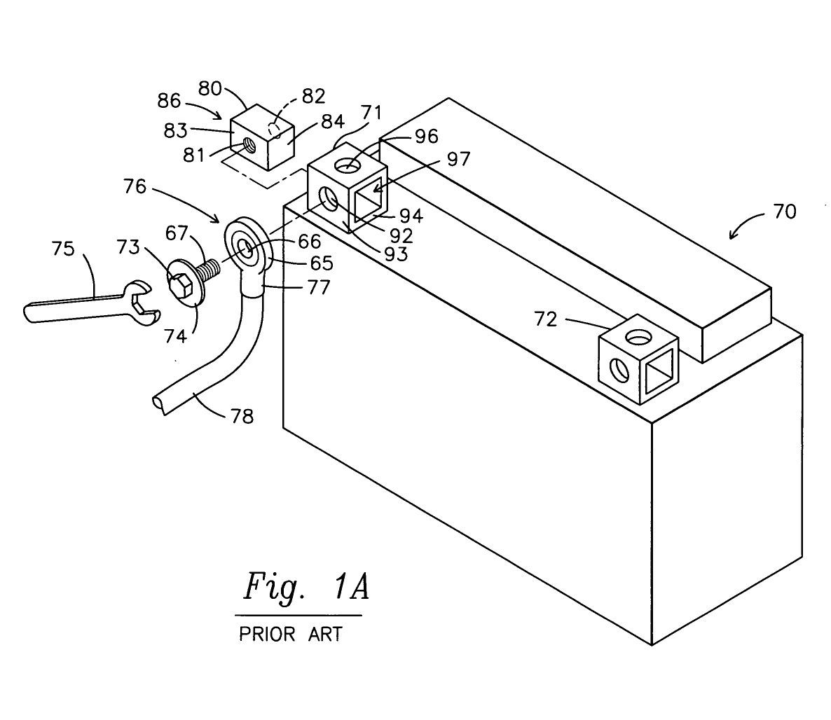

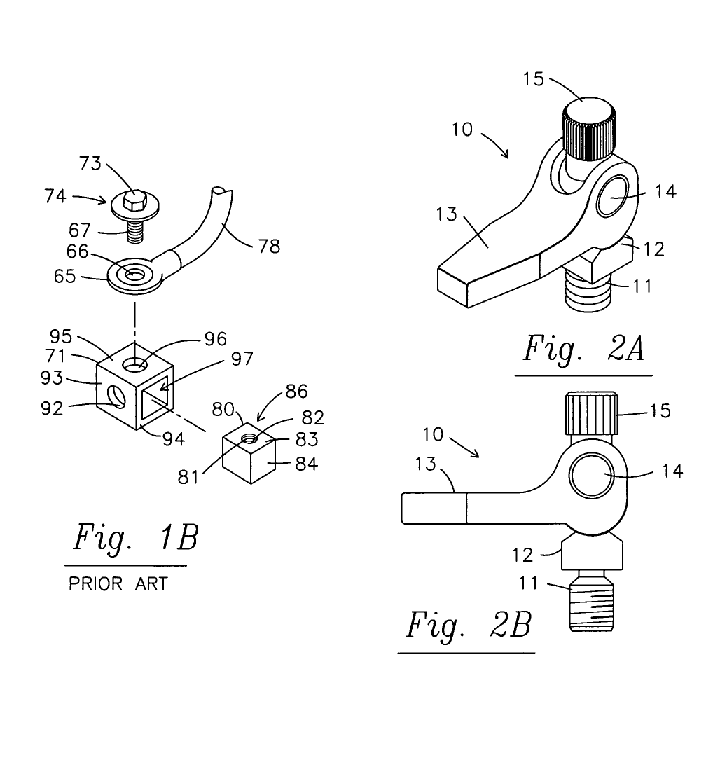

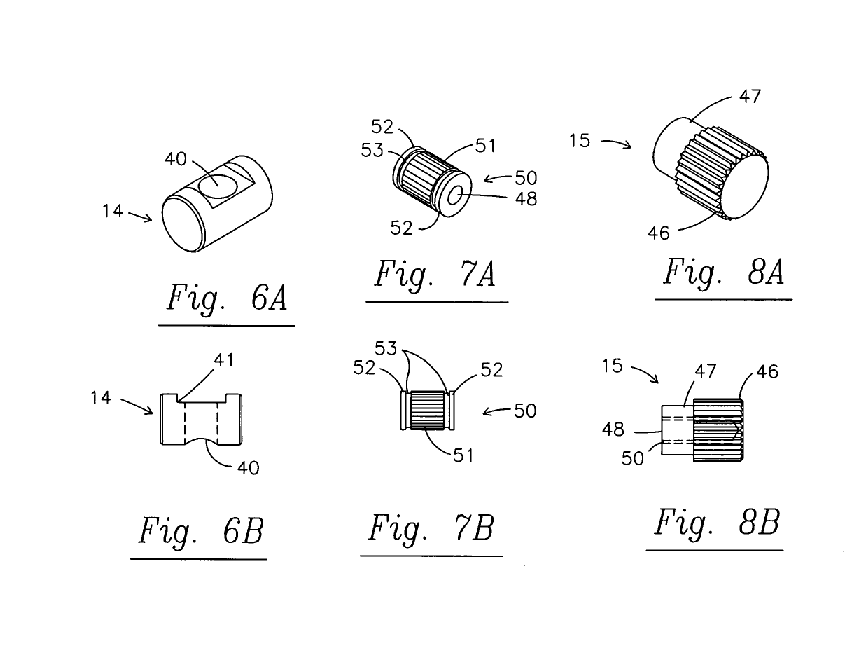

A description of the preferred embodiment of the present invention will be best understood by referring to FIGS. 1-10 of the accompanying drawings wherein like numerals refer to like parts.

Referring first to FIG. 1, a typical 12-volt battery 70 is shown with positive terminal housing 71 and negative terminal housing 72. Prior art battery cable terminals 76 have a generally circular distal end 65 or connector plate with aperture 66 to receive bolt 74. Bolt 74 has male threads 67 that engage with female threads 81 in the apertures 82 of nuts 80. Battery cable terminals or connectors 76 have a proximal end 77 that receives and is secured to battery cable 78. Bolts 74 are fastened and unfastened with a wrench 75 to firmly contact battery cable terminals 76 to a face 93 of terminal housing 71 and establish an electrical connection. Terminal housing 71 most typically has a front face 93, a top face 95, a back wall and a bottom which are connected about passageway 97 proceeding laterally through the housing formed by the aforementioned faces and walls. In the most typical terminal housing 71 configuration, front face 93 has an opening 92, and top face 95 has an opening 96 sized to received bolt 74. A nut 80, typically in form of a rectangular prism or cube, is then positioned within passage 97 so that its aperture 82 aligns with opening 92 if the connector plate of battery cable 78 is to be fastened to the front surface 93. The male threaded shaft 67 of bolt 74 is passed through aperture 66 of the connector plate 65 and then into opening 92 on the front surface 93 of terminal housing 71 and into mate with the female threads 81 in opening 82 of nut 80. The bolt 74 typically has a hexagonal head 73 that may be fastened with wrench 75.

Alternatively, the connector plate 65 of battery cable 78 may be fastened to the top surface 95 as shown in FIG. 1B. In this configuration, the nut 80 is rotated 90° so that the threaded opening 82 is vertical rather than horizontal and nut 80 is positioned in passageway 97 so that threaded opening 82 is aligned with opening 96 in the top surface 95 of terminal housing 71. The male threaded shaft 67 of bolt 74 again passed through aperture 66 of battery cable connector plate 65 then through opening 96 on top surface 95 of terminal housing 71 and into threaded opening 82 of nut 80. Fastening bolt 74 tightly presses the connector plate 65 against the top surface 95 creating a good electrical connection.

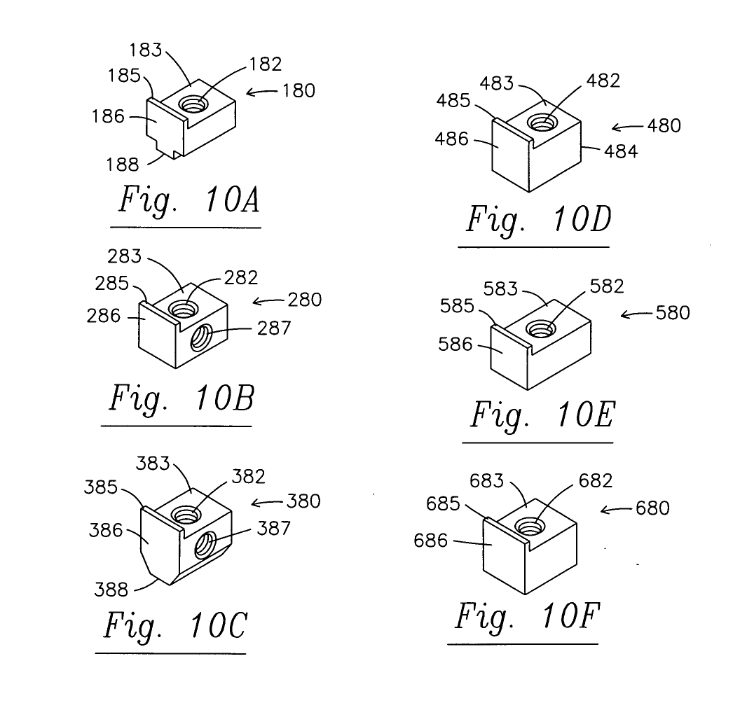

In use, terminal housing hardware is notorious for being difficult to align for fastening. The battery hardware may also be difficult to turn and it may be necessary to try to break corrosion or binding between bolt and battery cable terminal by tapping the hardware with hammer or attempting to rotate battery cable connector 76 while a wrench 75 engaging bolt 74 is being turned. Due to the confined spaces in which batteries are often located, bringing the desired axial forces to play upon the battery hardware is frequently difficult. A battery cable clamp 10 shown in FIG. 2A, generally of the type designed for use with side terminal batteries and described in U.S. Pat. No. 7,029,338 and incorporated herein by reference, may be advantageously used in the present invention, taking the place of the traditional bolt 74, so that the battery cable terminal 76 may be fastened and released by hand, and with an improved fastening nut 480 shown in FIG. 10D, may be easily aligned.

As shown in FIGS. 2A and 2B, a preferred battery cable clamp 10 comprises a bolt or clamp shaft 11, a seat 12, a handle 13, a pin 14, and a cap or locknut 15.

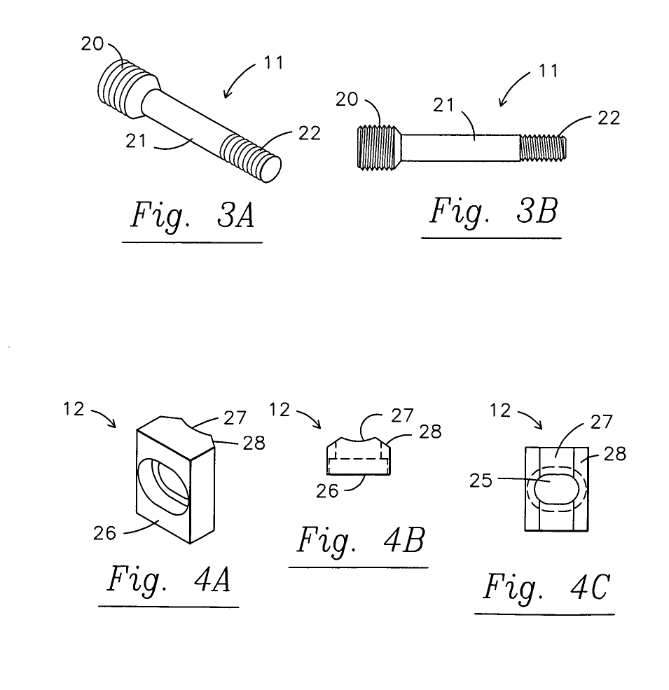

FIGS. 3A and 3B show the clamp shaft 11 has a relatively large diameter distal end 20 with male threads to be received within the female threads of the apertures 82 of nuts 80 positioned within terminal housings 71, 72 of battery 70, a central shaft section 21, and a proximal threaded end 22 of lesser diameter than distal end 20. Received over the proximal end 22 of clamp shaft 11 is seat 12. The proximal end 22 of clamp shaft 11 passes through opening 25 in seat 12 until seat 12 is retained by the larger distal end 20 of clamp shaft 11. The flat bottom surface 26 of seat 12 abuts distal end 20 of clamp shaft 11 and the central section 21 of clamp shaft 11 passes through aperture 25, said aperture 25 preferably having an ovular configuration. The ovular configuration allows the seat 12 to work with handles having unusually exaggerated cam sections. The top surface of seat 12 has a concave section 27, or cam surface, centrally located wherein the concave surface extends axially in a direction perpendicular to the major axis of the ovular aperture 25. At either end of the concave surface in the direction of the major axis of aperture 25 are raised end sections 28.

Pin 14 is positioned in lateral opening 32 of handle 13. Handle 13 and pin 14 are threaded with proximal end 22 of clamp shaft 11 passing through aperture 40 of pin 14. The base portion 30 of handle 13 rests in the concave section 27 of seat 12 and aperture 40 of pin 14 is positioned on the central section 21 of clamp shaft 11. Handle 13 has handle portion 31 and base portion 30. In addition to lateral opening 32 adapted to receive pin 14, base portion 30 has a bottom opening 33 that is generally oriented against cam seat 12, and a top opening 34. The central portion 21 of clamp shaft 11 passes through top and bottom openings 33 34. Top and bottom openings 33, 34 are generally ovular with front and back edges acting as stops to permit only limited angular rotation of handle 13 with respect to clamp shaft 11. Preferably about 45° of angular rotation is allowed. Furthermore, the orientation of lateral opening 32 within base 30 of handle 13 is off-center so that when the handle section is oriented approximately perpendicular to clamp shaft 11, the thickest portion or cam section 35 of the base is interposed between pin 14 and cam seat 12. Preferably the cam section 35 is off center an exaggerated amount of at least 0.15 inches and preferably 0.16 inches. When the handle section 31 is angularly rotated away from its position normal to the clamp shaft 11, a thinner section of the base 30 is interposed between pin 14 and cam seat 12. Cam section 35 is formed from wings 38 and 39 of base 30 that are on either side of bottom opening 33. Similar, but thinner wings, 36, 37 are on either side of top opening 34, and permit the proximal end 22 of clamp shaft 11 to protrude.

As previously described, the pin 14 is received over proximal end 22 of clamp shaft 11 and is positioned within lateral opening 32 of handle 13. The pin 14 has a central aperture 40 to allow the proximal end 22 of clamp shaft 11 to pass through, and pin 14 is oriented with recess 41 upwardly facing.

Finally, the components of the battery cable clamp 10 are held in place by the attachment of cap or locknut 15 shown in FIGS. 8A, 8B which has a proximal knurled portion 46 and a narrower distal portion 47. The end cap 15 also has a threaded aperture 48 which is screwed onto the male threads of proximal end 22 of clamp shaft 11. The distal portion 47 abuts the upward recess 41 of pin 14. To provide adequate strength for end cap 15, it is desirable to include a metal insert 50 in the center. Insert 50 may be made of stainless steel and has threaded aperture 48 which is held in end cap 15. In order to secure the insert 50 from axial movement with respect to cap 15, insert 50 has raised end sections 52 separated by channels 53 from central portion 51 of insert 50. To hold insert 50 rotationally secure with respect to cap 15 the central section 51 is serrated. Thus, when end cap 15 is formed about insert 50, insert 50 is securely held within the end cap and provides additional strength at the interface with male threads of proximal end 22 of clamp shaft 11.

When the battery cable clamp 10 is fully assembled, the handle portion 31 is rotated out of normal orientation from clamp shaft 11 so that a relatively thin portion of base 30 is interposed between seat 12 and pin 14. Then the male threaded distal end 20 of clamp shaft 11 is passed through aperture 66 of battery cable terminal plate 65, then through an opening 92, 96 in the terminal housing 71 and then threaded into the female threads 81 of opening 82 of nut 80. The battery cable clamp 10 is hand tightened by turning knurled portion 46 of locknut 15, which causes clamp shaft 11 and its threaded distal end 20 to turn. After being turned sufficiently to engage male threads of distal end 20 with female threads 81 of opening 82, handle portion 31 is depressed to a position normal to clamp shaft 11 and substantially parallel with the surface of terminal housing 71. This has the effect of interposing thicker cam section 35 between seat section 12 and pin 14, which applies pressure between male threads of distal clamp section 20 and the threads 81 of opening 82 on nut 80. This securely presses the battery cable terminal connector 76 against the surface of terminal housing 71 to ensure a good electrical connection. The pressure exerted between male and female threads also holds clamp 10 securely in place.

When it is desired to remove the battery cable terminal 76 from the terminal housing 71, 72, the handle section 31 of clamp 10 is rotated out of normal which removes the cam section 35 from its position between pin 14 and seat 12, thereby relieving pressure between male threads of distal clamp shaft 20 and female threads 81 of the opening 82. This permits the battery cable clamp connector to be removed by hand by rotating knurled surface 46 of end cap 15 to disengage the threaded bolt end 20 from nut 80, thereby permitting the clamp 10 to be removed from the nut 80 and terminal housing opening 92, 96 and the battery cable terminal to be disengaged from terminal battery surface 93, 95. Preferably, the handle 13, seat 12, and end cap 15 will be made of glass filled nylon, and the end cap 15 has a stainless steel insert 50 within aperture 48 for added strength. The end cap 15 may also be permanently fastened, as by adhesive, to the distal end 22 of clamp shaft 11 once the clamp 10 is assembled. The pin 14 and clamp shaft 11 are both preferably made of stainless steel and thereby all of the components are resistant to rust and corrosion.

It has been noted that bottom aperture 33 and upper aperture 34 of handle 13 are ovular or elongated in nature, this permits the angular rotation of handle 13 with respect to shaft 11 about pin 14. Preferably, about 45° of rotation is allowed by these openings, which is sufficient to insert or remove the cam section 35 from between the pin 14 and seat 12. If the handle section 31 were raised more than 45° from normal with the clamp shaft, it could require additional clearance between the side of battery 70 and adjacent structures or the battery compartment. It is to be noted that the handle section 13 is held to the clamp shaft 11 by pin 14. Pin 14 and therefore handle section 13 rotate freely in the axial direction about lock shaft 11. This permits the handle section 31 to be oriented in any direction needed to fit within the space of the battery compartment.

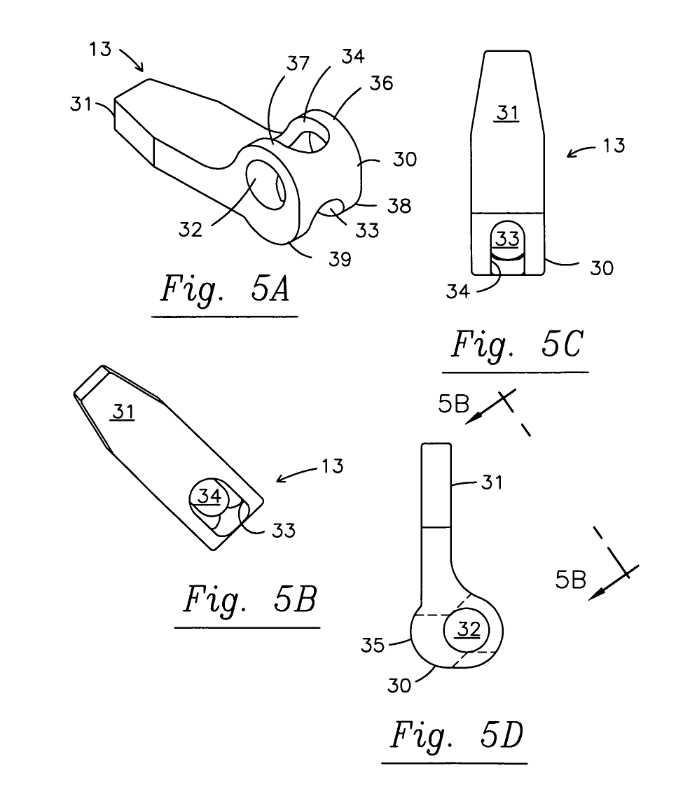

It may also be noted in FIG. 5B that the handle section 31 is offset from the axial center pin 14 to the side of cam 35 on the base 30 of handle 13 by about 0.12 to 0.14 inches. In this fashion, even when the handle section is rotated angularly with respect to clamp shaft 11 by about 45°, due to the offset of handle section 31 and the movement of handle 13 and cam seat 12 with respect to lock shaft 11 permitted by ovular opening 25, the knurled portion 46 of locking cap 15 is still accessible through upper aperture 34 of handle 13. This permits the battery cable clamp 10 to be threaded or unthreaded from the female threads 81 of the nut 80 by manually turning the knurled portion 46 of the locknut 15 regardless of the axial or angular position of the handle section 31.

While merely using the bossed battery cable clamp 10 of FIGS. 2-8 improves the speed and ease of fastening and unfastening battery cable 78 from the terminals 71, 72, the present invention contemplates the use of self-positioning nuts 180-680 shown in FIGS. 10A through 10F. It will be seen with reference to FIG. 1A, that nut 80 will slide laterally through passageway 97 and it is necessary to manually position opening 82 of nut 80 in alignment with opening 92 in front surface 93 of terminal housing 71. However, corresponding nut 480 shown in FIG. 10D when inserted into passageway 97 is restrained by lip 485 extending from trailing wall 486 so that the threaded opening 482 is substantially aligned with opening 92 on the front surface 93 of terminal housing 71. Lip 485 typically extends in the same direction as threaded opening 482, however it may also advantageously be positioned at a 90° angle to the orientation of opening 482. When the leading edge 484 of nut 480 is inserted into passageway 497 of terminal housing 471, lip 485 is restrained by perimeter 494 surrounding lateral passageway 497. When nut 480 is positioned with opening 482 facing upward, this positions opening 482 directly beneath opening 496 in the top surface 495 of terminal housing 471. Alternatively, when opening 482 is positioned horizontally, the positioning effect of lip 485 causes opening 482 to be aligned with opening 492 in the side surface of terminal housing 471.

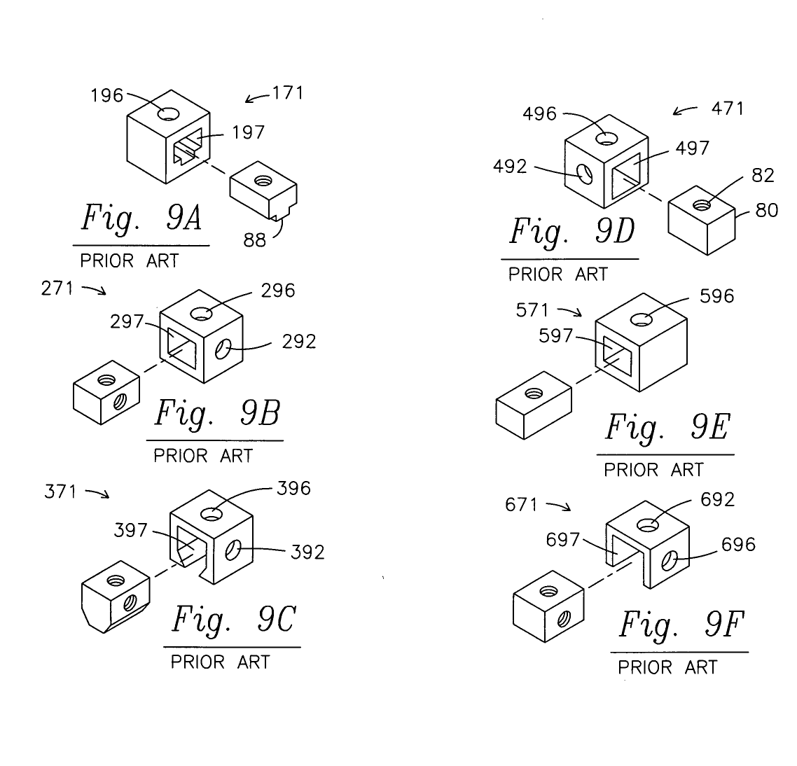

FIGS. 9A-9F depict a variety of known terminal housings 171-671 with lateral passageways extending fore to aft 171, 471 as well as side to side 271, 371, 571, 671. In addition, nuts 80 may have only one threaded opening 82 or may have a pair of threaded openings if the configuration of nut 80 and lateral passageway 97 is such that nut 80 may not be rotated.

Although preferred embodiments of the present invention have been disclosed in detail herein, it will be understood that various substitutions and modifications may be made to the disclosed embodiment described herein without departing from the scope and spirit of the present invention as recited in the appended claims.

1. A battery cable terminal connector for connecting a battery cable to a terminal housing comprising
(a) a battery cable clamp with
(i) a shaft having a threaded distal end, a central portion and a threaded proximal end;
(ii) a cam seat having an opening received on the central portion of the shaft and a bottom surface facing the threaded distal end of the shaft and a top cam surface;
(iii) a pin being received within a lateral aperture of a handle, said pin having an aperture received over the central portion of the shaft;
(iv) said handle having a base section with both a cam section and the lateral aperture, and a handle section; and
(v) a locknut mounted to the proximal end of the shaft and thereby restraining the pin and cam seat on said shaft; and
(b) a nut received within the terminal housing having a leading edge, a first aperture to receive the threaded distal end, a trailing edge and a positioning lip extending from the trailing edge and preventing the trailing edge from being received within the terminal housing.

2. The battery cable terminal connector of claim 1 wherein the nut is in the shape of a cube.

3. The battery cable terminal connector of claim 1 wherein the nut is in the shape of a rectangular prism.

4. The battery cable terminal connector of claim 1 wherein the nut has a second threaded aperture normal to the first aperture.

5. The battery cable terminal connector of claim 1 wherein the terminal housing comprises front, top, back, and bottom surfaces defining a lateral passageway therebetween.

6. The battery cable terminal connector of claim 1 wherein the top surface has an opening and when the leading edge of the nut is introduced into the lateral passageway, the positioning lip restrains entry of the nut into the passageway beyond a point where the first aperture of the nut is aligned with the opening.

7. The battery cable terminal connector of claim 1 wherein the front surface has an opening and when the leading edge of the nut is introduced into the lateral passageway, the positioning lip restrains entry of the nut into the passageway beyond a point where the first aperture of the nut is aligned with the opening.

8. The battery cable terminal connector of claim 7 wherein the top surface has an opening and when the leading edge of the nut is introduced into the lateral passageway, the positioning lip restrains entry of the nut into the passageway beyond a point where the first aperture of the nut is aligned with the opening.

9. The battery cable terminal connector of claim 8 wherein the leading edge of the nut may be introduced into the lateral passageway with the first aperture directed upward to align with the opening in the top surface.

10. The battery cable terminal connector of claim 8 wherein the nut may be introduced into the lateral passageway with the first aperture directed forward to align with the opening in the front surface.

11. The battery cable terminal connector of claim 1 wherein the nut, shaft, cam seat, pin, handle and locknut are fabricated from non-corrosive materials.

12. The battery cable terminal connector of claim 1 wherein the positioning lip extends from a side of the nut in a normal alignment with the first aperture.

13. The battery cable terminal connector of claim 1 wherein the positioning lip extends from a side of the nut in a parallel alignment with the first aperture.

14. A method of securing a battery cable to a terminal housing utilizing a battery cable terminal clamp having a shaft with a threaded distal end, a central portion and a threaded proximal end of relatively small diameter than the distal end, a cam seat having an opening received on the central portion of the shaft and a bottom surface facing the threaded distal end of the shaft and a top cam surface, a pin being received within a lateral aperture of a handle said pin having an aperture received over the central portion of the shaft, comprising the steps of:
(a) inserting a leading edge of a nut with a threaded aperture into a lateral passageway of the terminal housing until a positioning lip on a trailing edge of the nut restrains further insertion of the nut;
(b) passing the threaded distal end of the clamp through a battery cable terminal aperture and through an opening in a face of the terminal housing and engaging the threaded distal end of the shaft with the threaded aperture of the nut while the cam section is not interposed between the pin and cam seat;
(b) turning the locknut and thereby the shaft to engage at least several revolutions of threads;
(c) angularly rotating the handle section with respect to the shaft to interpose the cam section between the pin and cam seat and thereby secure the battery cable terminal against the face of battery housing.

15. The method of claim 14 wherein positioning lip of the nut acts to align the threaded aperture of the nut with the opening in the face of the housing.

16. The method of claim 14 wherein the terminal housing has a top face with an opening and a front face with an opening.

17. The method of claim 16 wherein the nut may be rotated to align the threaded aperture with either the opening in the top face of the terminal housing or the opening in the front face of the terminal housing.

18. The method of claim 14 wherein the lateral passageway proceeds from front to back of the terminal housing.

19. The method of claim 14 wherein the lateral passageway proceeds from side to side of the terminal housing.

20. A battery cable terminal connector for connecting a battery cable to a terminal housing of the type defining a lateral passageway and at least one surface with an opening comprising
(a) a fastening bolt with a distal threaded end sized to fit through the opening;
(b) a nut received within the lateral passageway of terminal housing having an aperture to receive the threaded distal end of the bolt, said nut having a leading edge and an opposite trailing edge with a positioning lip extending from the nut so that the positioning lip does not fit within the lateral passageway and restrains the trailing edge of the nut from proceeding through the lateral passageway.
